(19) United States
(12) Patent Application Publication
(10) Pub. No.: US 2007/0198725 A1
(43) Pub. Date: Aug. 23, 2007

(54) System and method for utilizing contact information, presence information and device activity

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 10/960,135

(22) Filed: Oct. 6, 2004

(51) Int. Cl. G06F 15/16

(52) U.S. Cl. 709/227

(57) ABSTRACT

A method and system utilizes presence information for a plurality of presence service clients is disclosed. In one aspect, the method and system include determining the presence information for the presence service clients, individually tailoring the presence information for presentation to each of a portion of the presence service clients, and presenting the tailored presence information to the portion of the presence service clients. In another aspect, the method and system include associating a component or a data entity of a device with presence information such that the component or the data entity corresponds to a first of the presence service clients. In this aspect, the method and system also include providing a presentity for the first presence service client. A second of the presence service clients corresponds to a user. Each presentity communicates with a presence service on behalf of the first and second presence service clients.

### CROSS-REFERENCE TO RELATED APPLICATIONS

The present application is related to co-pending U.S. patent application Ser. No. ______ [I254-3277], entitled “SYSTEM AND METHOD FOR UTILIZING CONTACT INFORMATION, PRESENCE INFORMATION AND DEVICE ACTIVITY,” filed concurrently herewith, and assigned to the assignee of the present application. The present application is related to co-pending U.S. patent application Ser. No. 10/900,558 [I250-3202P], entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576 [I257-3202P2], entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application.

### FIELD OF THE INVENTION

The present invention relates to presence services and more particularly to providing and integrating the use of presence information for devices, device components, and users.

### BACKGROUND OF THE INVENTION

Instant messaging (IM) services provide a well known mechanism for allowing computer users to communicate online for example by sending a message or chatting with another user. Such services are typically provided by AOL, MSN, Yahoo, and other similar service providers. Certain data associated with users of such IM services is known as presence information. Presence information typically consists of one or more presence tuples, which represent the status, an optional activity address, and other information relating to each user. The status of the user can simply be open or closed, when the computer system will or will not accept instant messages for the user. Other examples of the status of the user can include “online”, “away from my desk”, “stepped out”, or “on the phone”. Based on the status of a user, other users may decide whether to initiate activities with the user.

Presence tuples may also include contact information. Contact information includes contact addresses at which a user can be reached. The contact addresses can include MMS, email, postal addresses, ftp addresses, phone number(s), facsimile numbers and other mechanisms available for reaching a particular user, as well as contact priorities. Contact priorities indicate the best or preferred (highest priority) mechanism for reaching a user. For example, in certain instances, a user's email account may have a higher contact priority than his cell phone, and vice versa.

Systems which store and provide presence information are known as presence services. IM is one type of application which may be built which makes use of a presence service. More information on IM, presence services, and presence information can be found at the jabber.org/jeps site. For example documents jep-0132.html, and jep-0119.html are of interest. In addition, the ietf.org site contains internet related documents related to presence information and IM. Such documents include draft-ietf-impp-cpim-pidf-08.txt in the internet-drafts section of the ietf.org site, as well as rfc2778.txt and rfc2779.txt in the rfc section of the ietf.org site.

As part of IM services, a conventional friends list is often supported. Such a conventional friends list provides a user with information from the present tuples of other users (e.g. other users of the IM service) who are associated with the user. More specifically, status information for the “friends” is provided in the friends list. For example, while a user is online, the conventional friends list is typically displayed in a window on the user's display. Using the friend's list, a user can determine whether to send a message to an entity on the friends list. For example, if a particular friend's status is “busy” or “away from my desk,” the user may opt not to attempt to start a chat session with that particular friend.

An IM user is represented to the IM service through an IM client. The client sends status information reflecting the user's status to the presence service via a presentity. A presentity interacts with a presence service to provide presence information to the service concerning the client it represents. The presentity may be a component of the client or an external service. The user provides presence information concerning him/herself by interacts with the client through a presence user agent (PUA). A PUA may be a component of the client or an external service. In a typical IM client the PUA is simply the interface the user interacts with to change his/her status.

An IM client retrieves presence information, such as friends list data, from a presence service through a watcher. A Watcher interacts with the presence service to receive presence information concerning other users. Watchers come in several varieties. Two common varieties are fetchers which request presence information as needed and subscribers which subscribe to events related to presence tuple additions, deletions, updates, and other alterations. An IM client displays presence data, namely the user's friends list, through a watcher user agent (WUA). As with presentities and PUAs, watchers and WUA may be part of the presence service client or may be external services used by or acting on behalf of the client.

Watchers can take any action based on the information received from a presence service. This action follows a rule or rules determining the action(s) to be taken. Rules can be expressed in code or provided as input to a watcher. In this sense, a watcher contains a rule interpreter or invokes an external rule interpreter to carry out the rules.

Conventional methods and system include various mechanisms for managing presence information. For example, U.S. Pat. No. 6,668,173 describes one conventional mechanism for incorporating location information into presence information. Other conventional methods and systems describe how multiple contact addresses can be used to integrate different messaging systems, for example by relaying contact information via an email. U.S. Pat. Nos. 6,430,604 and 6,654,790 describe examples of such conventional systems. Finally, contact priorities may be managed. For example, a user may indicate that certain contact information, such as email or an office phone number are preferred over other contact information, such as cellular or home telephone numbers.

Moreover, instant messaging allows limited association between the actions that a user is taking on a device and the status of the user. More particularly, some conventional IM applications that reside on the device have internet radios incorporated into the application. When a user plays the radio, the conventional IM application notes that the internal radio is being used and alters the user's status, for example to “busy”. Similarly, some conventional IM applications take note of activity on a keyboard for the device. The IM application monitors the activity on the keyboard for the device on which the IM application resides. If the keyboard is not used for a period of time the IM application may change the user's status to “idle”.

Although conventional IM services and conventional friends lists are useful, one of ordinary skill in the art will readily recognize that there are significant drawbacks to the current methods of managing and utilizing presence information. For example, presence tuples typically represent users only. Activity of applications or other components of the device is integrated with the user's status. That is, a component's activity is only reflected directly in the status of the user, as in the radio example above. There is no mechanism for directly indicating the status of the component to the IM service. Moreover, when a user is engaged in multiple activities over a short-period of time, these activities lead to rapid changes in the user's status but may fail to adequately reflect the user's status from the standpoint of the user's availability or other purposes. Further, the activities that directly affect user status are tightly integrated with IM clients. Stated differently, such activities exclude other components from having any effect on the user's status in the presence service. It is desirable for the component activity and state to be integrated with a user's status in a more flexible and simple manner. Further, in most situations user status information, contact information, location information, and contact priorities typically have to be adjusted by the individual user. Users often forget to adjust this information when moving to a different location or engaging in other activities for which a change in their presence tuple would be appropriate. Further, current solutions merely report user status. For example, current IM systems allow users to send messages to other users regardless of their status resulting in distracting messages appearing when the user is otherwise busy.

Accordingly, what is needed is a method and system for extending presence services to integrate the status and capabilities of a device, its components, and applications with the device user's activity and presence information. The present invention addresses such a need.

### BRIEF SUMMARY OF THE INVENTION

The present invention provides a method and system for utilizing presence information for a plurality of presence service clients. In one aspect, the method and system comprise determining the presence information for the presence service clients, individually tailoring the presence information for presentation to each of a portion of the presence service clients, and presenting the tailored presence information to the portion of the presence service clients. In another aspect, the method and system comprise associating a component or a data entity of a device with presence information such that the component or the data entity corresponds to a first of the presence service clients. In this aspect, the method and system also comprise providing a presentity for the first presence service client. A second of the presence service clients corresponds to a user. Each presentity communicates with a presence service on behalf of the first and second presence service clients.

According to the method and system disclosed herein, the present invention allows the presence tuples of presentity clients to be dynamically harmonized and used to update the capabilities of watcher clients.

### BRIEF DESCRIPTION OF SEVERAL VIEWS OF THE DRAWINGS

FIG. 1 is a diagram of the interaction between the system and the service in accordance with the present invention.

FIG. 2A is a diagram of one embodiment of a presence service client illustrating the client presence service components in accordance with the present invention.

FIG. 2B is a diagram of an alternate embodiment of a presence service client illustrating the client presence service components in accordance with the present invention.

FIG. 2C is a diagram of one embodiment of a device in accordance with the present invention.

FIG. 3 is a more detailed diagram of a portion of one embodiment of the device in accordance with the present invention.

FIG. 4 is a high-level flow chart of one embodiment of a method in accordance with the present invention for harmonizing presence information and capabilities of subscribers on a device.

FIG. 5 is a more detailed flow chart of one embodiment of a method in accordance with the present invention for harmonizing presence information and capabilities of subscribers on a device.

FIG. 6 is a high-level flow chart of one embodiment of a method in accordance with the present invention for updating the presence information based upon changes in the subscriber's presence information.

FIG. 7 is a more detailed flow chart of one embodiment of a method in accordance with the present invention for updating the presence information based upon changes in the subscriber's presence information.

FIG. 8 is a high-level block diagram of one embodiment of a method used by a rule interpreter in processing presence information.

### DETAILED DESCRIPTION OF THE INVENTION

The present invention relates to presence services. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for utilizing presence information for a plurality of presence service clients. In one aspect, the method and system comprise determining the presence information for the presence service clients, individually tailoring the presence information for presentation to each of a portion of the presence service clients, and presenting the tailored presence information to the portion of the presence service clients. In another aspect, the method and system comprise associating a component or a data entity of a device with presence information such that the component or the data entity corresponds to a first of the presence service clients. In this aspect, the method and system also comprise providing a presentity for the first presence service client. A second of the presence service clients corresponds to a user. Each presentity communicates with a presence service on behalf of the first and second presence service clients.

Embodiments of the method in accordance with the present invention are described in the context of a particular system. One of ordinary skill in the art will readily recognize that features of the embodiments of the method in accordance with the present invention can be implemented in another device.

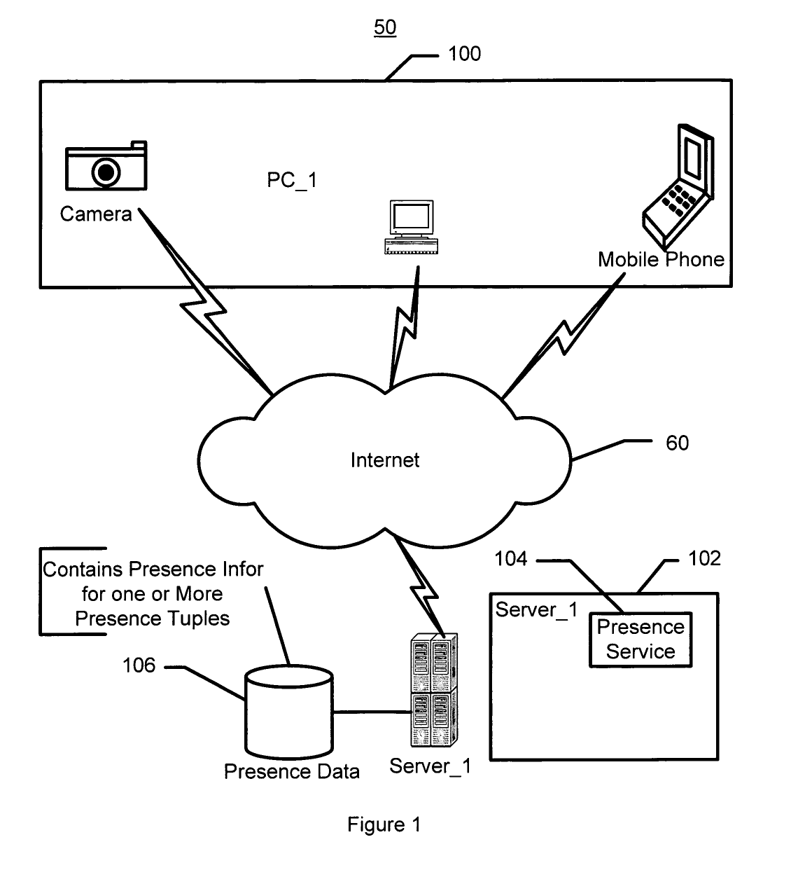

To more particularly describe the method and system in accordance with the present invention, refer to FIG. 1, depicting a diagram 50 of the interaction between embodiments of systems 100 and the service 104 in accordance with the present invention. The system 100 can be implemented in devices, such as the camera, the mobile phone and the PC, are collectively referred to as devices 100. Note that the system 100 could also be implemented using other devices (not shown). Thus, the present invention will be described in terms of particular devices, such as cellular or other telephones, camera phones, and digital cameras. However, one of ordinary skill in the art will readily recognize that the method and system in accordance with the present invention can include other and/or additional devices. The service 104 is a presence service, or IM service, used to manage presence information for the devices 100. In a preferred embodiment, the service 104 is used to manage global presence information, or information for the associated user(s) of the device 100. The overall system 50 indicates that activity is provided between the systems 100 and the server 102 via the internet 60. However, note that another mechanism, including an internal network, might be used.

The service 104 interfaces with the presence data 106. The presence data 106 may be implemented as a database. Although the presence data 106 is depicted as having a particular location remote from the devices 100, nothing prevents the presence data 106 from being stored in another location. For example, all or a portion of the presence data 106 may be stored in a memory (not shown) on the devices 100 or on another memory (not shown). The presence data includes presence information, preferably global presence data. The presence information is preferably in the form of presence tuples that are preferably indexed using the identity of the corresponding presentity client (or user). Such presence information preferably includes information such as the status, contact addresses, contact priorities, and locations of the devices 100. Moreover, the server 102 and service 104 may include and/or interface with additional components (not shown).

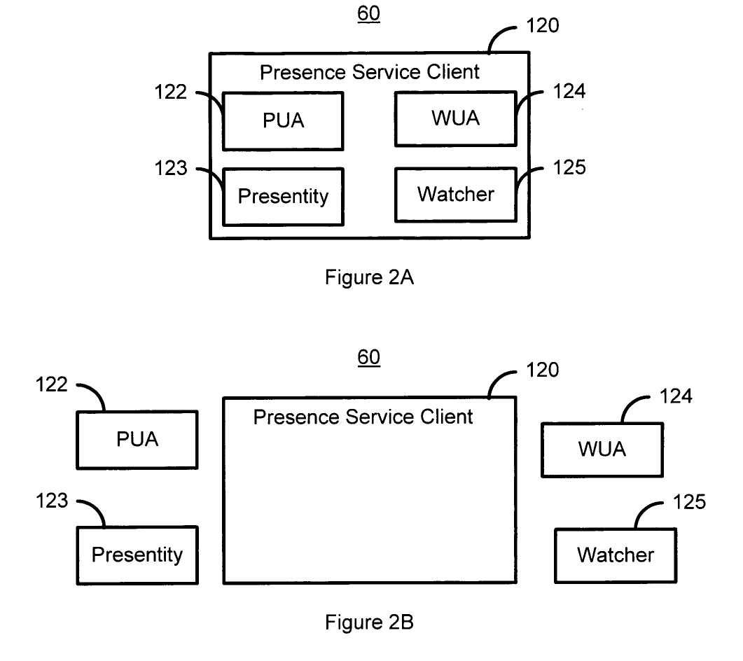

FIGS. 2A and 2B depict alternate embodiments of a presence service client which illustrate the structure of presence service clients in general that are used with the system 100 in accordance with the present invention. The presence service clients 120 are clients for and generally part of the device 100 depicted in FIG. 1. FIG. 2A illustrates a presence service client 120 where the presence service client components, the presence user agent (PUA) 122, watcher user agent (WUA) 124, presentity 123, and watcher 125, are part of the client. FIG. 2B illustrates a presence service client 120 where the presence service components 122, 123, 124, and 125 are external services uses by the IM client 120. These two figures illustrate the two extremes where all the components 122, 123, 124, and 125 are either internal or external to the presence service client. However, in accordance with the present invention, the presence service clients 120 can be associated not only with users, but also with the device and/or application and/or other components of the devices 100.

Referring to FIGS. 1, 2A, and 2B, in operation, a presentity 123 and watcher 125 in each device 100 cooperate to communicate with the service 104. In particular, the watcher 125 can receive user presence information including a user identity for a user and/or a device identity for the device 100, and changes actually made to the device's or user's status. The presentity 123 communicates with the user through the PUA 122, provides an identification of the user to the service 104, and indicates to the service 104 that particular events are occurring for one of the devices 100. The watcher 125 receives from the service 104 the status of the user, particularly in response to a notification that the activities on the device have been initiated or changed. The watcher 125 communicates with the user through the watcher user agent (WUA) 124 to display presence information it has received.

FIG. 2C is a diagram of one embodiment of a system 100 in accordance with the present invention. The system 100 is preferably implemented on a device, such as a cellular phone, camera phone, or digital camera. The system 100 preferably includes a number of presence service clients; collectively known as presence service clients 110, a phone service 114, a camera service 116, presence service client 120, other applications 112, and other components and services 119. The presence service clients 110 may be presentity clients, watcher clients, or both. If they interact with the user they may have a PUA or a WUA as illustrated by the IM Client's 120 PUA 122 and WUA 124. If a component has a presence tuple associated with it, then it is a presentity client. If a component receives presence information from a presence service either directly or on its behalf it is a watcher client. Thus, the system 100 includes components of the device that are also presence service clients 110, 114, 116, and 120.

A user of the device 100 can also be considered to be a presentity client and/or a watcher client via PUA(s) and WUA(s). Moreover, a presentity client and/or a watcher client could be associated with a data element, such as a file. In such cases, accesses to the file may cause changes in presence information 172, or vice versa. The presence service clients 110 thus include applications 112 as well as components and services 119 of the system 100 that have presence information associated with them and/or that use presence information. Further, the presence service clients 110 can also include users, as in a conventional IM system. Note that the present invention is described in terms of particular watcher and presentity clients. However, one of ordinary skill in the art will readily recognize that the method and system apply to other watcher and presentity clients not inconsistent with the present invention.

The client presence service 170 stores and manages the presence information 172 for the presence service clients 110 of the system 100. Thus, a user presence tuple 174, and other presentity client presence tuples 180 are shown. Specific presentity clients represented are text editor presence tuple 176, print service presence tuple 178. In addition there is other markup 182. The other markup 182, is described below. Although depicted separately the other markup 182 may be part of each presence tuple. In the preferred embodiment the other markup 182 is used to manage rules, events, and subscriptions. The presence tuples 174, 176, 178, and 180 are the presence information for various presence service clients 110 of the system 100. Thus, the status, contact address(es), contact priorities, location and other portions of the presence information 172 for the presence service clients 110 is stored and managed by the client presence service. Thus, the client presence service 170 manages presence information including status information, contact information, subscriber information, rules, and events which trigger changes in the presence information. Also depicted is a set of system rule interpreters 160. While each watcher is in effect a rule interpreter, in the preferred embodiment the system rule interpreters 160 follow a design pattern which allows them to be managed by the presence service outside of the normal subscription system. This is described further in the description of the other markup 182.

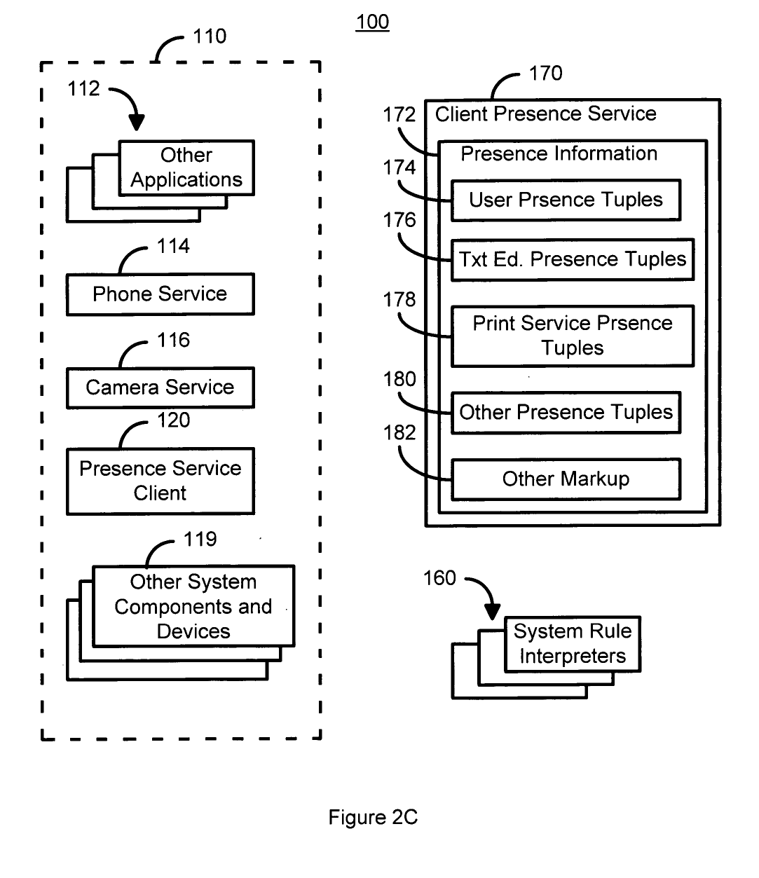

FIG. 3 depicts one embodiment of the other markup 182. The other markup includes the rules 184, including the Rule Interpreter ID used to identify the system rule interpreter(s) 160 and the rule specification. The other markup 184 also specifies the management of events 186 including but not limited to status events 187, contact information events 188 and other markup events 189. This specifies the events that may occur for a presence tuple and for which watchers may subscribe. The other markup 182 further includes subscriptions 190 including but not limited to IM subscription 191, camera subsystem subscription 192, and print subsystem subscription 193. The subscriptions 191, 192, and 193 indicate the subscribers (i.e. watchers) 120, 116, and 114 which are to receive notifications when events occur for a presence tuple.

Referring to FIGS. 2C and 3, note that the system 100 depicted is a camera phone. Consequently, the presentity clients and watcher clients include a phone service application 114 and a camera service application 116 in addition to other applications 112. In an alternate embodiment in which the device does not have telephone and/or camera capabilities, the device 100 may not include the phone service application 114 and/or the camera service application 116. For example, in an alternate embodiment, the system 100 might be a camera, mobile phone or the PC. In such an embodiment, the system 100 might include additional and/or other applications and components. The presence service clients corresponding to such application and components may, therefore, be different in such an embodiment. The function of the system 100 is described below primarily in the context of the (generic) presentitiy clients and watcher clients of the other components and devices 119 and corresponding (generic) presence tuples 180. However, the present invention applies with full force to other presentitiy clients and watcher clients among system components 110 and other presence tuples 174, 176, and 178. The presence service clients 110, each have watchers, presentities, or both.

The system rule interpreter(s) 160 are used in processing a plurality of rules 184. The rules 184 indicate how a change in the presence information 172 for one of the presence service clients 110 on the system 100 affects the presence information 172 and/or a capability for one or more of the watchers for the presence service clients 110. The system rule interpreter(s) 160 update the presence information 172 and/or the capability of the remaining watcher(s) based on the change in the presence information and the rules 184. When an event occurs affecting a presence tuple, the client presence service 170 invokes a system rule interpreter 160 identified by the Rule Interpreter ID passing in the rules for the presence tuple and the associated event. The system rule interpreter 160 then takes actions as indicated by the rules given the event. Watchers (fetchers and subscribers) (not expressly depicted in FIG. 2C) of the presence service clients 110 may also make use of system rule interpreters 160. For example, a change in the status, location, contact address, or contact priorities may be detected. The change in status, location, or contact address may be detected by the phone service 114 requesting as a presentity client that the client presence service 170 change the status, location, contact address, contact priorities, or other information in the corresponding presence tuples 180. Assume that the phone service 114 has a system rule interpreter and rules associated with it and that it has at least one subscriber for the event. Based upon this change in the presence information the presence service invokes the associated rules interpreter, the rules 184 may indicate that another portion of the presence information 172 of the phone service 114 or the presence information 172 for another watcher 112, 116,120, or 119 should be updated. The system rule interpreters 160 determine what the update should be based upon the event and the rules 184. The presence service also notifies each subscriber of the event. Each subscriber may take actions based on the event according to the rules encoded in the subscriber and/or may invoke a rules interpreter and rule set to react.

For example, a user may open his phone service 114. The phone service 114 uses its presentity (not specifically depicted in FIG. 2C) to request its status to be changed to “open”. When the user is entering or selecting a callee, the phone service 114 presentity requests the client presence service 170 to update the phone service 1-14 status to “initiating call”. Based on the rules 184, a system rule interpreter 160 processing this event in the context of the rules 184 may provide a resultant indicating that the first status change to “open” does not cause a change to the presence information of the user. In contrast, a system rule interpreter 160 may also determine that the second change to “initiating call” may result in the user's status being set to “On the phone”. This status change may also result in the user's contact information being updated so that the calling phone's number/address is given the lowest priority, and email may become the top contact priority because email does not require the user's immediate attention. These updates would also be performed based upon the system rule interpreters 160 processing the rules 184 and the second status change. Other watchers (i.e., rule interpreters) may behave in a similar fashion in response to the events.

System rule interpreter(s) 160, subscribers, and or other watchers associated with a particular presence tuple 180 may directly request a change to the status of the presence tuple 174, 176, 178, or 180 for a different presentity client. The affected presentity client would subscribe to or otherwise watch for its own status change events, and respond appropriately, or may have a system rule interpreter respond to events on its behalf. In this manner, a watcher can be activated, deactivated, or have its behavior changed in some other way based upon changes in the system 100, the rules 184 and the resultants from the rule interpreters 160. Alternately, a first subscriber of the presence service clients 110 could subscribe to events associated with another presentity client as well as have a set of rules and rule interpreter(s). 160 configured to modify the first subscriber's behavior and status.

Presence service client(s) 110 may play an active or a passive role in the update of the presence information 172. In an active role, a presence service client 110 explicitly requests a change to its status, or other presence information, which is then used to determine whether a change to the user's status, or the status of other presence service client(s) 110, is required by the rules 184. An active presence service client 110 with the proper access privileges may directly request a change to the user's presence tuple 174. In a passive role, the system 100 infers the status of a given presence service client 110 based on its use of system resources. The system 100 makes a request to change the components activity info or may request a change to the user's presence tuple 174 directly based on the rules 184 and rule processors 160 associated with the related events 186.

In the system 100, system rule interpreters 160 allow for response to events beyond those of the ordinary watcher clients. In its simplest form, a set, or portion, of the rules and a rule interpreter can be a hard-coded piece of software. In this sense, all watchers are rule interpreters. In the preferred embodiment, rules 184 are specified using a declarative markup language (such as an XML grammar) which is well-known in the field of Al and rules-based decision making. System rule interpreters 160 are preferably plug-in modules which process the rules 184 to perform the actions specified by the markup language, such as updating presence information. A system rule interpreter 160 may use standard learning algorithms to adjust the rules based on past history or other source of contextual information. System rule interpreters 160 allow the response to events to be configurable through changes to the XML rules markup and allows for one rule interpreter 160 to respond on behalf of multiple clients. As stated earlier, subscribers and other watchers may use the system rule interpreters 160 to carry out their response to presence information events.

The system 100 also allows for contact addresses and contact priorities to be added, removed, or modified based on a change in the presence information 172, particularly a change in status. In particular, the events 186 include contact information events 188 which indicate alterations to the contact addresses and priorities of the presence information 172 to be altered. For example, when a user is editing a particular financial worksheet a portion of the rules 184 may indicate that the user is not to be interrupted. A rule interpreter 160, subscriber, or other watcher thus may request that the user's status, for example as represented by the user's presence tuple 174, be changed to “do not interrupt”. For such a status, only messages that do not require immediate attention are allowed. This change in status generates a status event which when processed by a system rule interpreter 160, subscriber, or other watcher may alter the contact information to restrict and modify the priorities of the user's contact addresses. Further, the communications clients associated with the user's addresses may be enabled or disabled as appropriate and may filter the messages to be brought to the user's attention to match the new status.

The rules 184 are configurable by the user or any authorized entity, possibly including the presence service clients 110. System rule interpreters 160 can preferably be plugged in to the system 100 and mapped to various sets of rules 184 and events, particularly status events 187 and contact events 188. Sets of rules 184 and system rule interpreters 160 can be linked together so that multiple sets of rules 184 can be applied for any given status change event 187. In general, any change to a presence tuple 174, 176, 178, or 180 generates an event. Other watchers may share the same capabilities as just described for system rule interpreters 160. As discussed above, the subscribers of the presence service clients 110 can include components, services and users. As a result, components, services, and users may subscribe to particular events 186. A subscriber of the presence service clients 110 may subscribe to its own events. In response to such events, a subscriber may alter its activity and/or change its own status, contact address, contact information, capabilities, or other features. These changes may result in other changes to the subscriber or another of the presence service clients 110, or 120. Thus an event may initiate one or more chains of related activities and associated events. Note that a chain may have cycles providing for feedback loops useful for “learning.” In such an embodiment, feedback may be provided between the subscribers of the presence service clients 110, the system rule interpreters 160, other watchers, the client presence service 170, or other portions of the system 100. As a result, the subscribers, system rule interpreters 160 and other watchers may be informed of the affects of events on the system 100 and learn how updates may be better performed.

The system rule interpreters 160, subscribers, and other watchers may use learning algorithms to learn from user and system behavior to modify the rules 184 and apply new system rule interpreters 160. For example, a system rule interpreter 160 may track a user's reaction to interruptions. The system rule interpreter 160 may track whether user responded and what the response was. In cases where the user consistently ignores or turns off an interrupting component, the system rule interpreter 160 may modify the rules 184 associated with the interrupting components to disable them in these situations. Other watchers may perform similarly.

The status associated with each of the presence service clients 110 provides a detailed view of the user's current and past activity. Rather than directly reflecting this information in the user's status, the rules 184 may indicate that this activity is to be mapped to the various system states, including to a public user status available to others, for example via the service 104 depicted in FIG. 1. Referring back to FIGS. 2C-3, the status indicated in the presence information 172 of the client presence service 170 may be internal statuses that are generally not mapped to a user's status, the device status, or any other status that is publicly available and/or used to describe the gross behavior of the system 100. The actual status and level of detail made public may vary depending on the access privileges assigned to the requestor of the user's status information.

Similarly detailed statuses for one or more of the presence service clients 110 may be mapped to public status using activity changes over various timeframes, to determine when changes to the public status is warranted. For example, one or more rules 184 may be configured to determine how long an internal status of one or more of the presence service clients 110 persists before it warrants a change in the public status. Alternatively, one or more rules 184 may be configured to indicate that the internal state of particular presence service client(s) 110 should be sampled only at specified time intervals or specific times and update the user status at those times if warranted. Thus, a change in the presence information of one or more presence service clients 110 may be required to have a corresponding minimum time frame before the change is used for a particular purpose such as updating a status.

As discussed above, a data entity can be considered to be a presence service clients 110, allowing rules 184, system rule interpreters 160, and other features of the client presence service 170 to be applied to the data entity. As a result, the status and other presence information for data entity, such as a file, database record, or other data entity may be tracked. For example, the system 100 may track access to the data entity and alter the data entity's status data based on the rules 184 corresponding to the data entity.

In addition, through the rules 184, system rule interpreters 160, and other features of the system 100, different presence data may be selectively made available to different users based on various criteria. For example, a manager may be “Busy” as far as her employees are concerned, but “Available” as far as her boss is concerned. For example, the system rule interpreter 160 may, based on the rules 184 and the actual current status of the user, display a different status for different entities. For example, the user's status might be displayed to the user's spouse as “Napping” but “Busy” to the user's boss. Thus, the rules 184 may indicate that a presence service client's presence information is to be individually tailored to entities receiving the information. The tailored presence service information may then be presented to the appropriate entity. Thus the rules 184, system rule interpreters 160, and other watchers of presence service clients 110 are able to authenticate and authorize requests for presence information 172, particularly the user's presence tuple 174, and customize the response based on the identity of the requestor. In so doing, the system rule interpreters 160 and other watchers of the presence service clients 110 may take into account role or group information of the requestor as well as the user's current context. The user's current context is defined using the user's presence tuple 174, plus the presence tuple(s) 176, 178, and 180 of all relevant component(s) serving the user.

In the preferred embodiment, the system 100 is able to process its sets of rules 184 to determine the persistent relationships between the presence tuples 174, 176, and 180 and, therefore, to determine the relationships between the presence service clients 110 of the system 100. In a preferred embodiment, an API (not explicitly shown in FIGS. 1-3) is used by all system rule interpreters 160. Through this API, the system 100 is able to determine the presence tuples 174, 176, 178, and/or 180 affected by a given event and given system context. Both these capabilities allow the system to display the relationships among the presence tuples 174, 176, 178, and 180 the system and simulate various scenarios. This makes the system 100 much easier to configure and manage.

Moreover, watchers for presence tuples for certain device(s) can subscribe to events of other presence tuples, and therefore other devices. Thus, a presence tuple 174, 176, 178, or 180 watcher may subscribe to both its own events, such as a change in its own status, as well as events related to other presence service clients 110. A subscribe API for the presence tuple 172, 176, 178, and/or 180 that is to be subscribe to is preferably called to perform the subscription. Through the subscribe API, a subscription delivery mechanism such as a callback routine or a message queue and the event or events of interest are defined.

Thus, the system 100 can be used to provide a variety of features that allows presence information, such as status, location, contact information, to be utilized, including updating status information such as contact information, user activity, and location changes. The system 100 may also dynamically modify contact information and contact priorities based on user activity and location information. Further, presence service clients including software component or services (with the right access privileges) are allowed to access, retrieve, and update presence information. Moreover, the system 100 may apply feedback and learning, for example to rules 184 and system rule interpreters 160. A distinction between private and public statuses may be made both for the user's privacy and to ease the system requirements such that rapid changes in the private status information for a particular subscriber need not result in changes to a status of the device 100 or other public information for the particular subscriber. In addition to extending presence information to components and services, presence information changes can be based on other activity, for example related to a data entity.

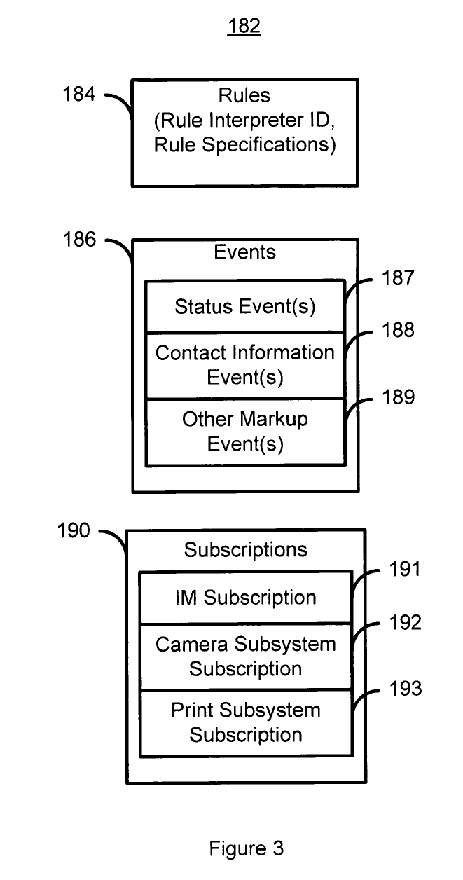

FIGS. 4-8 are flow charts depicting embodiments of methods 200, 210, 220, 236, and 280 in accordance with the present invention. The methods 200, 210, 220, 236, and 280 are preferably performed using the system 100. However, in an alternate embodiment some portion of the methods, particularly the methods 210, 220, 236, and 280 may be performed without the use of the system 100. For example, updating of contact information, including addresses and priorities, based upon a status or location change may be accomplished using another system (not shown). Similarly, alteration of a subscriber's capabilities based upon changes in presence information may be accomplished using portions of the methods 210, 220, 236, and 280 implemented by another system (not shown). The selective mapping of changes in private presence information to public presence information such as a public status may be accomplished in another system. The same is true for smoothing of rapid status shifts, in which rapid changes in the presence information for one or more subscribers is not automatically mapped to other presence information, including the public presence information of the device or user. The ability to change presence information based upon accessing of data entities and customization of the data displayed to outside requesters may also be accomplished using the method 210, 220, 236, and 280 implemented in another system (not shown). Note that the present invention will be described in terms of particular methods having certain steps. However, one of ordinary skill in the art will readily recognize that a method in accordance with the present invention could have additional and/or other steps not inconsistent with the present invention.

FIG. 4 is a high-level flow chart of one embodiment of a method 200 in accordance with the present invention for harmonizing presence information and capabilities of presence service clients on a device. The method 200 is preferably implemented using the system 100. Consequently, the method 200 is described in the context of the system 100.

Referring to FIGS. 2C-4, the rules 184 are provided, via step 202. The rules 184 indicate how a change in the presence information for presentity client(s) on the device 100 affects the presence information 172 and/or a capability for a remaining portion of the watchers of the presence service clients 110. One or more of the system rule interpreter(s) 160 or other watch(s) are used to determine how and what portion of the system 100 to update based upon a change in the presence information 172 and the rules 184, via step 204. In a preferred embodiment, step 204 includes determining how the presence information and/or the capability of each of the remaining portion of the watcher clients is to be altered. Thus, using the method 200, the system 100 can harmonize different types of presence information and capabilities of the presence service clients, as discussed above.

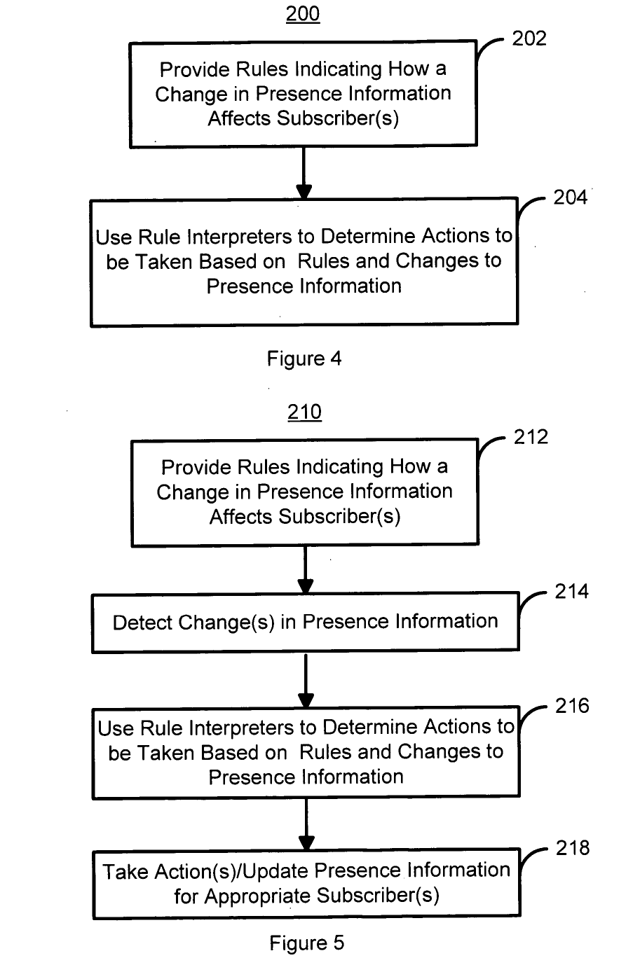

FIG. 5 is a more detailed flow chart of one embodiment of a method 210 in accordance with the present invention for harmonizing presence information and capabilities of presence service clients on a device, such as the system 100. The method 210 is preferably implemented using the system 100. Consequently, the method 210 is described in the context of the system 100.

Referring to FIGS. 2C-3 and 5, the rules 184 are provided, via step 212. Thus, step 212 is analogous to step 202. A change in the presence information is detected, via step 214. The change detected in step 214 is preferably a status change, a location change, a contact address change, a rule change, or an access of data linked to the presence information 172.

The system rule interpreter(s) 160 and/or other watchers are used to determine how and what portion of the system 100 to update based upon the change detected in step 214 and the rules 184, via step 216. In a preferred embodiment, step 216 includes determining how the presence information and/or the capability of each of the remaining portion of the watcher clients are to be altered. Thus, step 216 is analogous to step 204 of the method 200 in FIG. 4.

Referring back to FIGS. 2C-3 and 5, the presence information 172 and/or capabilities of one or more of the watcher clients 110 are updated based on the detection in step 214, and the resultant determined by the system rule interpreter(s) 160 and/or other watcher(s) in step 216, via step 218. Thus, at least one of the status change, the location change, the contact address change, the rule change, or the access of the data and based upon a resultant of the at least one system rule interpreter and/or other watcher, the presence information capable of including at least one of a second status, a location, a contact address, a contact priority, a capability of the device, and at least one rule. Thus, based upon a change in the presence information 172 of a particular presence service client 110, the capabilities of and/or presence information of that or another presence service client 110 may be updated. For example, based upon a status or location change, status (including private and/or public statuses), contact addresses, contact priorities, capabilities of the system 100 or presence service clients 110 or rules 184 may be altered. Consequently, using the method 210, the presence information 172 can be used for a managing a variety of features of the system 100.

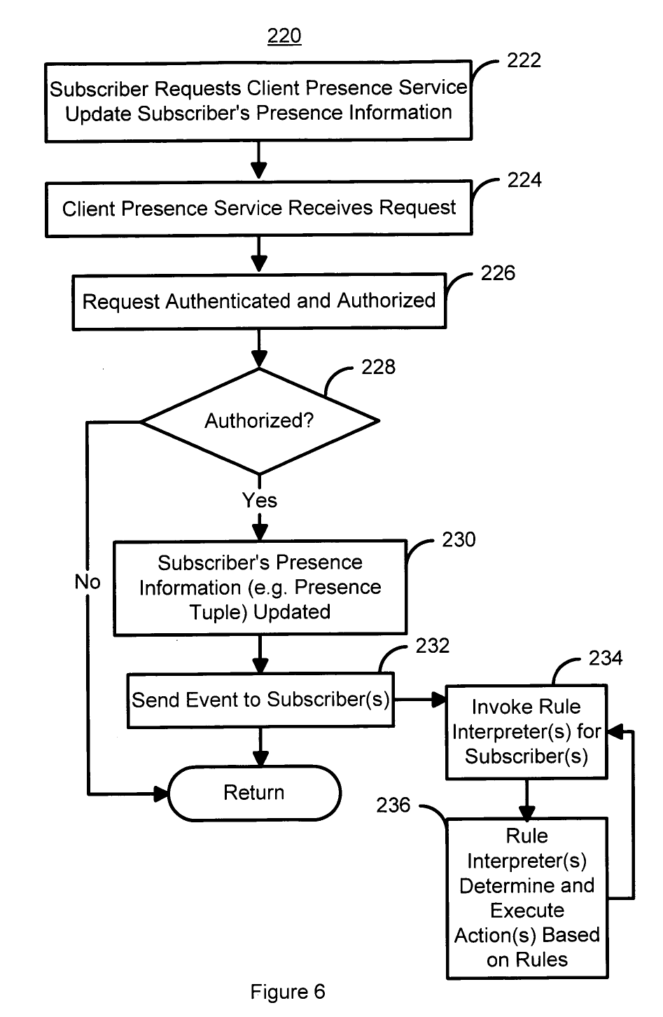

FIG. 6 is a more detailed flow chart of one embodiment of a method 220 in accordance with the present invention for updating the presence information based upon a changes in the presentity client's presence tuple. The method 220 is preferably implemented using the system 100. Consequently, the method 220 is described in the context of the system 100. However, nothing prevents the method 220 from being implemented by-another system.

A presence service client 110 requests that the client presence service 170 update the presence service client's presence tuple 180, via step 222. The request sent in step 222 preferably includes identification information for the presence service client 110 as well as identification information for the presence tuple 180 for which an update is requested. The client presence service 170 receives this request, via step 224. The client presence service 170 authenticates and authorizes the request, via step 226. Consequently, the client presence service 170 ensures that the presence service client(s) 110 are allowed to update the presence tuples 180 requested. It is determined whether the presentity client 110 is authorized to request the update, via step 228. If not, then the no update is made and the system returns. If the presentity client 150 is authorized, then the client presence service 170 updates the appropriate presence tuple 180, via step 230. The event, the updating of the presence tuple 180, is sent to the appropriate system rule interpreters, subscribers, and other requesting watchers 110 associated with the affected presence tuple, via step 232. Thus, the system rule interpreters 160 and watchers of the presence service clients 110 to which the event is sent in step 232 can include the component and/or service initialing requesting the update as well as other components, services, and/or the user. The system rule interpreters 160 and watchers of the presence service clients 110 receive the event via step 234. In invoking the system rule interpreters 160 and other watchers of the presence service clients 110, information regarding the event and affected presence tuple are passed as input. Consequently, for the method 220, the particularities of the update requested in step 224 and made in step 230 are sent to the system rule interpreters 160 and other watchers of the presence service clients 110. The system rule interpreters 160 and other watchers of the presence service clients 110 determine and take the appropriate actions to take based upon the rules 184 and the event(s), via step 236. Therefore resultant of step 236 is preferably an identification and an execution of the actions specified by the rules 184. Because these actions may result in additional events causing system rule interpreters 160 and other watchers 110 to be invoked, one can see, the method 220 allows chain reactions to be established and thus a particular event may have multiple effects.

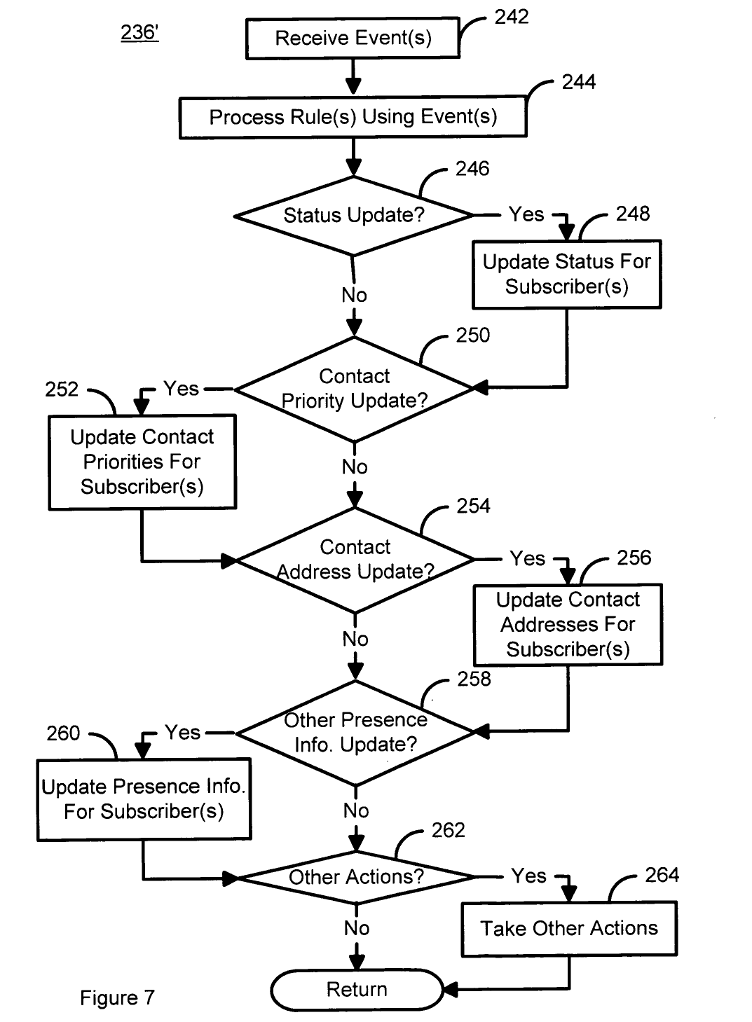

FIG. 7 is a high-level flow chart of one embodiment of a method 236′ used by rule interpreters in processing presence information. The method 236′ is preferably used in performing the step 236 of the method 220 depicted in FIG. 6. The method 236′ is preferably implemented using the system 100. Consequently, the method 236′ is described in the context of the system 100. However, nothing prevents the method 236′ from being implemented by another system.

The event is received by the appropriate system rule interpreters 160 or other watcher, via step 242. The appropriate system rule interpreters 160 or other watchers process the event based on the rules 184 and provide a resultant, via step 244. The resultant provided in step 244 is preferably an action(s) that is to be taken. It is determined if the resultant is an update for one or more statuses, via step 246. If so, then the statuses of the presence tuples 180 of the appropriate presence service client(s) 110 are updated, via step 248. If there is no status update and/or if the status has been updated, it is determined whether the resultant is an update for one or more contact priorities, via step 250. If so, then the contact priorities of the status tuples 180 for the appropriate presentity client(s) 110 are updated, via step 252. If there is no contact priority update and/or if the contact priorities have been updated, it is determined whether the resultant is an update for one or more contact addresses, via step 254. If so, then the contact addresses of the status tuples 180 for the appropriate presentity client(s) 110 are updated, via step 256. Step 256 may thus including adding, deleting, or modifying the contact addresses for the appropriate presence service client(s) 110. If there is no contact address update and/or if the contact addresses have been updated, it is determined whether the resultant is an update for another part of the presence information of the presence service client(s) 110, via step 258. If so, then the other portion of the presence information for the appropriate presence service client(s) 110 is updated, via step 260. If there is no other presence information update and/or if the presence information has been updated, it is determined whether the resultant is another action, via step 262. If so, then the other action is taken, via step 264. The method 236′ then returns. Thus, using the method 236′, the appropriate actions are determined and taken based upon events occurring for the various presence service clients 110. As a result, presence information 172 for various presence service clients 110 can be managed and used to improve operation of the device.

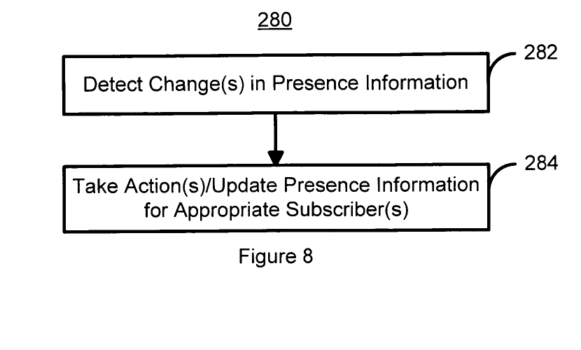

FIG. 8 is a high-level flow chart of one embodiment of a method 280 in accordance with the present invention for updating the presence information based upon a change(s) in the presentity client's presence information. At least one of a status change, a location change, a contact address change, a rule change, or an access of data linked to a first status is detected, via step 282. In a preferred embodiment, step 282 is performed through communication between the client presence service 170 and the presence service client(s) 110. The appropriate action is taken based on the change in the presence information, via step 284. In one embodiment, in step 284, the presence information or other information related to the presence service client(s) 110 or another presence service client is updated based on the detection in step 284. For example, contact information for, status of, capabilities of, and/or rules relating to the presence service clients 110 may be altered in step 284. In updating the items described above, it is generally first determined whether the presence information and/or the capability of the presence service client is to be updated. In addition, other actions could be taken in step 284. For example, step 284 could include determining whether the change in the presence information of the presence service client affects the presence information or a capability of any of the presence service clients and if so, how to update the presence information and/or the capability of the presence service client. This includes the presence service client having the change in the presence information and/or other presence service client(s). In such an embodiment, step 284 may also include updating the presence information of the presence service client(s) based on the change in the presence information. For example, a change in the presence information for a component of the device could be used to update the presence information, including contact priorities and other contact information, of a user or other component(s). Similarly, a change in the presence information for user could be used to update the presence information of a component of the device. Step 284 could also include individually tailoring the presence information for presentation to each user and presenting the tailored information to the users. For example, the user's status might be displayed to the user's spouse as “Napping” but “Busy” to the user's boss. Step 284 could also include utilizing the change the presence information only if the change is characterized by a minimum time. For example, the change in the presence information detected in step 282 might only be used for updating the user's presence information if the change lasts for a specified time or if sampling at specified intervals detects the change a particular number of times. Thus, step 284 might result in a variety of different actions being taken. In a preferred embodiment, step 284 is performed using the system rule interpreters 160, other watchers of the presence service clients 110, and client presence service 170. However, nothing prevents the use of another system for performing the step 284.

Thus, using the methods 200, 210, 220, 236, and 280, the different types of presence information and capabilities of the presence service clients can be updated and harmonized, as discussed above. Consequently, performance and ease of use of the device can be improved.

Note that the present application is related to co-pending U.S. patent application Ser. No. ______ [I254-3277], entitled “SYSTEM AND METHOD FOR UTILIZING CONTACT INFORMATION, PRESENCE INFORMATION AND DEVICE ACTIVITY,” filed concurrently herewith, and assigned to the assignee of the present application. The present application is related to co-pending U.S. patent application Ser. No. 10/900,558 [I250-3202P], entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576 [I257-3202P2], entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application. Consequently, in addition to the components and methods described herein, the system 100 and the methods 200, 210, 220, and 236 can be combined with the methods and system described in the above-identified co-pending patent applications.

A method and system for managing presence information and other portions of a device has been disclosed. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

1. A method for utilizing presence information for a plurality of presence service clients comprising:
determining the presence information of a presence service client of the plurality of presence service clients;
individually tailoring the presence information for presentation to each of a portion of the plurality of presence service clients and
presenting tailored presence information to the portion of the plurality of presence service clients.

2. The method of claim 1 wherein the portion of the plurality of presence service clients correspond to a plurality of users and wherein the individual tailoring further includes:
individually tailoring the presence information based upon at least one of an identity of each of the plurality of users, access privileges of each of the plurality of users, and a time.

3. The method of claim 1 wherein the presence service client is a user.

4. The method of claim 3 wherein the tailored presence information includes at least one status of the user.

5. The method of claim 1 wherein the presence service client is a component of a device.

6. The method of claim 1 further including:
detecting a change in the presence information; and
utilizing the change in the presence information if the change is characterized by a minimum time.

7. The method of claim 6 wherein the individually tailoring further includes:
individually tailoring the presence information after the change has been made to the presence information

8. The method of claim 6 wherein the minimum time corresponds to sampling at a specified interval.

9. The method of claim 6 wherein the minimum time is an amount of time the change persists.

10. A method for utilizing presence information for a plurality of presence service clients, the method comprising:
associating a component or a data entity of a device with presence information such that the component or the data entity correspond to a first of the plurality of presence service clients; and
providing a presentity for each of the first presence service client and a second of the plurality of presence service clients corresponding to a user, each presentity for communicating with a presence service on behalf of the respective first and second presence service clients.

11. The method of claim 10 further comprising:
providing at least one watcher for detecting a change in the presence information of each of the plurality of presence service clients.

12. The method of claim 10 wherein each presentity is configured to update the presence information of the the respective first and second presence service client based on the change in the presence information.

13. A computer-readable medium for utilizing presence information for a plurality of presence service clients, the program including instruction for:
determining the presence information of a presence service client of the plurality of presence service clients;
individually tailoring the presence information for presentation to each of a portion of the plurality of presence service clients; and
presenting tailored presence information to the portion of the plurality of presence service clients.

14. A computer-readable medium for utilizing presence information for a plurality of presence service clients, the program including instructions for:
associating a component or a data entity of a device with presence information such that the component or the data entity correspond to a first of the plurality of presence service clients; and
providing a presentity for the first presence service client and a second of the plurality of presence service clients corresponding to a user, each presentity for communicating with a presence service on behalf of the respective first and second presence service clients.

15. A system for utilizing presence information for a plurality of presence service clients comprising:
a plurality of presentities, each presentity for communicating with a respective presence service client of the plurality of presence service clients and for communicating with a presence service on behalf of the respective presence service client; and
at least one rule for indicating that the presence information be individually tailored for presentation to each of a portion of the plurality of presence service clients and for presenting the information to the portion of the plurality of presence service clients.

16. The system of claim 15 further comprising:
a client presence service for managing the presence information for each of the plurality of presence service clients.

17. The system of claim 15 wherein the portion of the plurality of presence service clients correspond to a plurality of users and wherein tie at least one rule indicates that the presence information be individually tailored for presentation based upon at least one of an identity of each of the plurality of users, access privileges of each of the plurality of users, and a time.

18. The system of claim 15 wherein the presence service client is a user.

19. The system of claim 18 wherein the tailored presence information includes at least one status of the user.

20. The system of claim 15 wherein the presence service client is a component of a device.

21. A system for providing presence information on a device having a component or a data entity, the system comprising:
a plurality of presentities, each presentity for communicating with a respective presence service client of the plurality of presence service clients and for communicating with a client presence service on behalf of the respective presence service client, the plurality of presence service clients corresponding to the component or the data entity and to at least one user.

22. The system of claim 21 wherein the client presence service for managing the presence information for each of the plurality of presence service clients resides on the device.

23. The system of claim 21 wherein each presentity is configured to update the presence information of the respective presence service client based on a change in the presence information.

24. The system of claim 21 further comprising:
a plurality of rules for use in determining whether a change in the presence information of a presence service client of the plurality of presence service clients affects the presence information or a capability of at least one of the plurality of presence service clients.

25. The system of claim 24 further comprising:
a plurality of rule interpreters for using the plurality of rules in determining how the change in the presence information affects the capability or the presence information of the at least one of the plurality of presence service clients.

26. The system of claim 21 further comprising:
at least one watcher for detecting a change in the presence information of the plurality of presence service clients.

27. An arrangement for utilizing presence information for a plurality of presence service clients on a device comprising:
a first presence service client corresponding to a component or a data entity of the device;
a second presence service client corresponding to a user; and
memory configured to store presence information for the plurality of presence service clients, the presence information including first and second presence tuples associated with the respective first and second presence service clients.

28. A system for utilizing presence information for a plurality of presence service clients comprising:
a server for communicating with the plurality of presence service clients, a presence service client of the plurality of presence service clients corresponding to a component or a data entity of the device; and
memory configured to store presence information for the plurality of presence service clients.
